(19) United States
(12) Patent Application Publication
(10) Pub. No.: US 2022/0107973 A1
(43) Pub. Date: Apr. 7, 2022

(54) COLLABORATIVE ANNOTATION AND ARTIFICIAL INTELLIGENCE FOR DISCUSSION, EVALUATION, AND RECOMMENDATION OF RESEARCH PAPERS

(71) Applicants: Robert DuBois Morris, Issaquah, WA (US); Avinoam Shmuell, Olga, WA (US)

(72) Inventors: Robert DuBois Morris, Issaquah, WA (US); Avinoam Shmuell, Olga, WA (US)

(73) Assignee: DropCite Inc., Issaquah, WA (US)

(21) Appl. No.: 17/496,582

(22) Filed: Oct. 7, 2021

Related U.S. Application Data
(60) Provisional application No. 63/088,792, filed on Oct. 7, 2020.

(51) Int. Cl. G06F 16/38; G06F 16/9536; G06F 16/335; G06F 16/34

(52) U.S. Cl. CPC G06F 16/382; G06F 16/34; G06F 16/337; G06F 16/9536

(57) ABSTRACT

A collaboration platform facilitates review of research papers by recommending papers to reviewers and managing annotation of the papers by the reviewers. The platform applies a model to analyze historical actions by a user with respect to the platform to predict an attribute of the user. Based on a match between the predicted attribute and the subject matter of a paper, the platform recommends at least one research paper to the user. As the user reads the paper, the platform receives an input from the user to define an annotation associated with the research paper. The user attribute is linked to the annotation and the annotation is published in association with the research paper, where the annotation is selected for display to a second user based at least in part on the attribute of the user.

### CROSS-REFERENCE TO RELATED APPLICATIONS

This application claims the benefit of U.S. Provisional Application No. 63/088,792, filed Oct. 7, 2020, which is incorporated herein by reference in its entirety.

### BACKGROUND

Peer review is the standard method for evaluation of scientific research papers. Review of research papers by experts in a related field can help ensure that the papers present rigorous science and advance their field. However, the traditional peer review process is slow and opaque and is usually limited to two or three reviewers. Once a research paper has been written, it can often take months for the paper to be reviewed. The final version of the paper that is published does not contain any information about the reviewers' comments, leaving readers without the benefit of the reviewers' insights.

Commentary on research papers is scattered across the internet on social media and other forums. In addition, researchers other than peer reviewers highlight and annotate digital copies of these same papers for their own use. At present, there is no available tool or platform that aggregates and integrates commentary and annotations from users across the Internet, or facilitates a broader and open discussion among researchers, which, when coupled with an evaluation system based on a combination of explicit scoring, comment sentiment analysis, and ratings of commentors, enables them to discover, obtain and share insights about the latest research findings and papers in an alternative and more timely manner than is possible via traditional peer review.

### BRIEF DESCRIPTION OF THE DRAWINGS

FIG. 1 is a block diagram illustrating components of a location, annotation, collaboration, and evaluation (LACE) review platform, according to some implementations.

FIG. 2 illustrates an example user interface for logging in to a browser application.

FIG. 3 illustrates an example user interface for managing subject matter preferences and expertise.

FIG. 4 illustrates an example user interface for displaying a list of recommended research papers.

FIG. 5 illustrates an example user interface for displaying a record of user activity.

FIG. 6 illustrates an example user interface with a certification statement.

FIGS. 7-9 illustrate example user interfaces for facilitating annotations of a research paper.

FIG. 10 illustrates an example user interface for receiving general comments and scores for a research paper.

FIG. 11 illustrates an example user interface for displaying a research paper.

FIGS. 12A-12C illustrate example user interfaces for filtering annotations.

FIGS. 13-14 illustrate example user interfaces for displaying a research paper with annotations.

FIG. 15 is a flowchart illustrating management of a process of annotation, collaboration on, evaluation, and recommendation of research papers, according to some implementations.

FIG. 16 is a block diagram illustrating an example of a processing system in which at least some operations described herein can be implemented.

### DETAILED DESCRIPTION

A collaboration platform facilitates review and discussion of scientific research papers based on annotation, collaboration, evaluation, and recommendation. The platform integrates comments from a network of users in line and adjacent to the underlying source material within a research paper, giving readers access to insights and discussion of the research by other experts in the context of the original online document so that readers can view, parse, and respond to the annotations of others, thereby turning a research paper into a dynamic, living document and aiding in the process of improving the research paper with reviewer's comments through subsequent revision and versioning. The platform collects and integrates comments from users dispersed across a network, which is composed of individual researchers as well as private groups using the system for internal purposes. In addition, a public facing website displays aggregated commentary. This shared commentary provides the foundation for a crowd-sourced or network-based review and evaluation system that relies on a broad network of participants to feed and support an analytics engine that provides a means of evaluating the merits of new research and its potential relevance to users of the system.

The collaboration platform (also referred to herein as a location, annotation, collaboration, and evaluation, or “LACE,” platform) uses ever-improving models to find the right “fit” between electronic documents and readers. “Fit” can include matching users and documents to serve the goal of generating high quality evaluations (mostly in the form of in-context commentary) for a given application, such as scientific research. To serve this goal, the platform can be configured to (1) drive engagement, to increase the number of documents read, the number of annotations posted on documents, and the number of reactions to those annotations; and (2) increase the quality of the annotations and thus the quality of the evaluation, which in turn will increase the rate at which high quality documents are detected.

To facilitate these operations, the collaboration platform includes a model to rank electronic documents by quality. The model can be trained initially using external data indicative of document quality. For example, in the realm of scientific publishing, this external data can include metadata extrinsically associated with scientific papers that is indicative of each scientific paper's likelihood of achieving recognition within a traditional framework of academic publishing. The model is then continuously improved by other signals gathered by the collaboration platform that correlate, confirm, and predict document quality. For example, as users annotate documents, the platform evaluates attributes of the annotations and the users who post them. These attributes, in turn, are used to build predictive models to detect the type of comment, the type of reader or commenter, and the type of reading behavior, that helps the system predict the quality of papers.

The “fit” of a user with a document can be represented as a mix of attributes that are more likely to drive a given user to interact with a given document, for example by reading the document, annotating the document, or sharing the document. The mix of attributes can include attributes of the user, attributes of the document itself, or attributes of annotations added to a document by other users. The models applied by the collaboration platform can generate predictions for documents that are likely to interest a particular user based on this mix of attributes. The models can also be continually improved as the mix of attributes changes over time for different users and different documents.

Attributes of users that are evaluated by the collaboration platform can include, for example:
Explicit profile data, such as education, employment, affiliations, declared expertise, declared topics of interest, or other biographical details;
Explicit or implicit behaviors with respect to document available through the platform, such as the documents a user chooses to read, the amount of time the user spends reading a document or a specified portion of a document, annotations the user chooses to react or respond to, or the user's similarity with other users in these respects; or
Connections to other users either through explicitly defined groups such as journal clubs or scientific societies or implicitly defined groups such as readers with similar expertise or reading patterns.

Attributes of annotations can include, for example:
Text of the annotation, including its length, language, or sentiment;
Tags a user associated with the annotation when creating the annotation;
Number and nature of replies to the annotation; or
Number of likes or other reactions to the annotation.

Attributes of documents that are evaluated by the collaboration platform can vary depending on the type of document as well as its stage in publication. These attributes can include, for example:
Text of the document;
Title and/or subject matter(s) of the document;
Authorship of the document, and any attributes of the authors such as names, institutions, education, or affiliations'
Publisher of the document;
Amount of time between submission for publication and publication
Number of versions of the document; or
Engagement with the document in one or more social media platforms.

By nature of machine learning, the attributes that are used, the attributes that are added or removed from the above lists, and the weighting of each attribute in the model, is subject to continuous change.

The collaboration platform further can provide tools to filter annotations based on explicit attributes of the annotations and their authors. In some implementations, long comment-and-reply threads can be collapsible, where only selected annotations are displayed initially. These collapsed threads can be expanded to see all annotations on a given document or sections within the document, in response to explicit user gestures.

When filtering comments, the collaboration platform can provide explicit attributes of the annotations or annotation authors, allowing users to explicitly select from among these annotations for filtering. Explicit annotation author attributes may include (but are not limited to) author's names, affiliations, declared expertise, inferred or derived expertise, or internal or external groups to which the author belongs. Explicit annotation attributes may include tags associated with the annotation, the time the annotation was posted, its length, etc.

Annotations may also be filtered according to the context in which they were posted, such as the event in which they were posted (such as a symposium, conference, journal club, or specific work meeting).

This filtering allows the users to efficiently scan an article for a specific type of annotations, gather annotations by specific context, or look only for annotations from a specific type of annotator.

Although various implementations are described herein with respect to applying the collaboration platform to scientific or research papers, any of a variety of types of documents can be subject to annotation and analysis by the LACE platform. For example, any of the following types of documents can be analyzed as described herein, instead of or in addition to research papers:
1. Recipes: the collaboration platform can be used to create collaborative inline annotation of recipes. Users comment on ingredients (amounts, sources, substitutions, additions, subtractions), techniques, and tools. Users can also like or dislike the comments or suggestions of other users, which could, in turn, be used to create evaluations of a commenters. User ratings of recipes can be weighted on how well they predict the consensus of recipes and how well they correlate with the tastes of other users. This could then be used to recommend recipes and highlight suggestions based on shared tastes among users.
2. Fiction and Poetry: The LACE platform can likewise be used to create collaborative inline annotation of original literary works. This can be useful, for example, in an editorial context, for one or more editors working to review a manuscript prior to publication, or for one or more literary scholars and critics to generate commentary on a previously published work. A collaboratively annotated version of published work can be made available to readers on the LACE platform so they could read the comments and discussion among participating scholars and critics inline and associated with the text itself.
3. Primary Source Legal Materials: In yet another example, the LACE platform can generate and collect annotations on primary source legal materials such as statutes, regulations or case law decisions. This would be of potential benefit to legal professionals in order to create research and practice materials, where expert commentary, from legal scholars and practitioners, is collected and displayed inline and in context to the primary source material. Legislators can likewise use the LACE platform to annotate and discuss pending legislation as part of the mark-up process, and to make drafts of proposed legislation available to the public and/or various interested parties in order to collect their comments.

Various examples of the invention will now be described. The following description provides certain specific details for a thorough understanding and enabling description of these examples. One skilled in the relevant technology will understand, however, that the invention can be practiced without many of these details. Likewise, one skilled in the relevant technology will also understand that the invention can include many other obvious features not described in detail herein. Additionally, some well-known structures or functions may not be shown or described in detail below, to avoid unnecessarily obscuring the relevant descriptions of the various examples. Further, the examples in this application of prior or related systems and their associated limitations are intended to be illustrative and not exclusive. Other limitations of existing or prior systems will become apparent to persons of ordinary skill in the art upon reading the following description.

The terminology used below is to be interpreted in its broadest reasonable manner, even though it is being used in conjunction with a detailed description of certain specific examples of the invention. Indeed, certain terms may even be emphasized below; however, any terminology intended to be interpreted in any restricted manner will be overtly and specifically defined as such in this Detailed Description section.

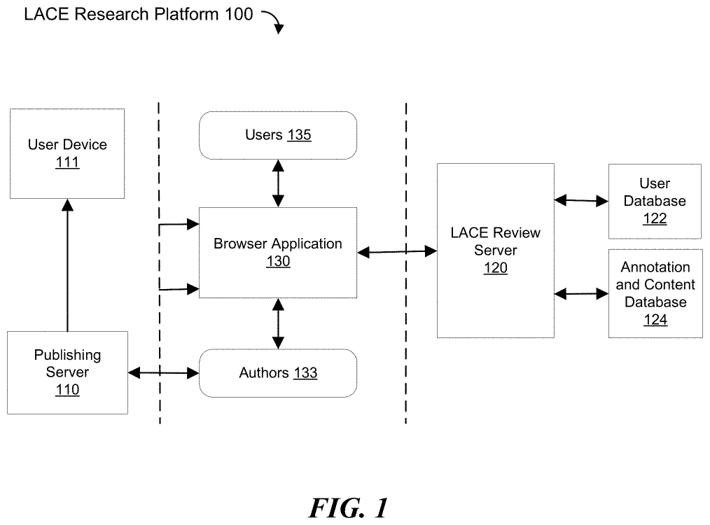

FIG. 1 is a block diagram illustrating components of a technology platform 100 that facilitates location, annotation, collaboration, and evaluation of research papers (a “LACE research platform”), according to some implementations. As shown in FIG. 1, the LACE research platform 100 can include a publishing server 110, a LACE review server 120, and a browser application 130. Other embodiments of the LACE research platform include additional or different components. For example, the LACE research platform 100 can include multiple independent publishing servers 110, or users can collaborate on annotating research papers using multiple copies of the same paper available as a PDF document on different users' devices 111, loaded locally into their respective instances of the browser application 120, independent of a publishing server 110 component.

The publishing server 110 publishes draft research papers prior to peer review of the papers, peer-reviewed research papers, or both draft and reviewed research papers. Authors 133 can upload papers to the publishing server 110 as soon as a manuscript is complete, enabling the authors to rapidly publish their work and enabling the public (e.g., users 135) to access cutting-edge research. The publishing server 110 can include one or more online archives that maintains and serves research papers, such as a preprint archive server or a publisher's archive server. Examples of the publishing server 110 include ArXiv.org (publishing physics research), BiorXiv.org (publishing biology research), ChemrXiv.org (publishing chemistry research), and MedrXiv.org (publishing medical science research). In other instances, the publishing server 110 serves as an archive of papers published elsewhere, such as the case with PubMed or PubMed Central. The publishing server 110 can be a system that is accessible to any person by a free or paid membership model, whether or not the person is a registered user of the LACE research platform 100. For example, users can access the research papers available through the publishing server 110 independently of the annotation functions, search functions, sharing functions, and other functionality enabled by the LACE research platform 100, as described herein with respect to various implementations.

The LACE review server 120 can serve four major functions: 1) it can manage user annotations, ratings, and reviews associated with research papers and store them in the annotation and content database 124, 2) it can allow for users to respond and react to the annotations of other users and store those responses and reactions and store them in the annotation and content database 124, 3) it can use data from the annotation and content database coupled with user attributes from the user database 122 to drive a machine learning/artificial intelligence algorithm to evaluate the quality and importance of a paper and store them in the annotation and content database 124, and 4) it can use those evaluations together with user attributes to recommend papers that fit each user's interests.

The server 120 can manage and store user annotations associated with research papers in any of a variety of document formats (such as HTML and PDF), whether the papers are published or unpublished. The annotated research papers managed by the LACE review server 120 can be papers accessed from the publishing server 110 or from a local storage associated with a user device 111. As users annotate research papers, the LACE review server 120 can store copies of the research papers with associated annotations. Alternatively, the review server 120 can maintain mappings between research papers and the annotations linked to the papers, without storing the papers themselves.

In some cases, the server 120 does not hold a copy of the research paper, such as when it does not have access to it but its users do. In these cases, the server 120 can store metadata associated with the paper, such as any publicly available basic document metadata on the paper: its title, authors, subject matter, or various identifiers may be included. The server 120 connects users across the network commenting on the same document using either a well-known URL (examples are URL behind a firewall or on an internal network shared by the users but inaccessible to the system), a unique ID (a DOI for example), or a unique hash (such as an MD5 hash or a PDF unique ID). Once an external ID such as a DOI is detected, the server 120 can attach publicly available metadata such as title, abstract, and authors list, etc. using that key.

The LACE review server 120 can maintain data associated with the annotations in an annotation and content database 124. The database 120 stores annotations received from users, user replies or reactions to those annotations, tags explicitly added to the annotations, and/or implicit data related to the user who created the annotation or the context in which the annotation was created. Each annotation can be stored with an identifier of the user who provided the annotation, an identifier of the research paper, and, in some cases, an identifier of a section of text with which the annotation is associated.

The LACE review server 120 can further maintain a user database 122. The user database 122 stores information associated with each user of the LACE platform 100, including explicit data affirmatively provided by the users and implicit data derived from the user's interactions with the platform 100. The data stored by the user database 122 for each user can include data such as a user identifier, expertise, rating, citation index, and interests. The user database 122 can further contain links to each user's profile(s) on research databases. As a user interacts with research papers and annotations, the LACE review server 120 captures salient gestures and interactions between users and the articles they read or review, including explicit gestures such as annotations, article recommendations, evaluations, replies to others' annotations, or tagging of annotations and replies, but also implicit gestures such as the time users spend on each section of the document or the time users spend reading other users' annotations. The data captured by the LACE review server 120 can be added to the user's profile in the user database 122 or processed to update the data stored in the database 122. For example, the review server 120 updates identifiers of the user's expertise or interests based on data such as the types of papers the user reads, the subject matter of papers or sections of papers the user annotates, and reactions of other users to the user's annotations. These data can also be used as part of assessment tool to evaluate the quality of a particular user's annotations.

The browser application 130 generates user interfaces to facilitate collection and display of user reviews, annotations, and annotation-driven discussion. The browser application 130 can include software that is executed with a browser on a user device 111 when the browser navigates to content from the publishing server 110 or when the user loads a local copy of an article also reviewed by other users. The browser application 130 can communicate with the LACE review server 120 to create and display user annotations associated with research papers. The browser application 130 can display research papers accessed from the publishing server 110. Alternatively, the browser application 130 can enable interaction with research papers stored in other locations and displayed by other applications. Some or all of the code responsible for the functionality of the browser application 130 described herein can reside on the publishing server 110, the LACE review server 120, or some combination of the two, in addition to or instead of in the browser.

The browser application 130 provides users with multiple mechanisms to organize papers. In some configurations, the application may offer users the ability to organize their reading in a library. Users may also organize groups for joint reading and review activities, and those groups may organize reading lists and tag them. These groupings at the individual and group level can then be further used to enhance the paper-to-paper similarity algorithm used to generate better recommendations for further reading for both groups and individual users.

The browser application 130 generates and displays various user interfaces to enable users to read research papers, add annotations, review and filter annotations from other users, and otherwise interact with research papers, as detailed further below. As users create annotations associated with a research paper, the browser application 130 adds data to the annotations that enable the LACE review server 120 to construct, via a process of continuous machine learning, ever-improving models to automatically tag papers and sections within the papers, to aid users both in identifying papers of interest to them, and to identify relevant sections within the papers. Recommendations for further reading can use full text index statistical methods, using the metadata on each research paper, the full text of each paper, system-generated tags, user-generated tags, the full text of users' annotations, and/or other data associated with the annotations such as users' expertise.

Furthermore, the browser application 130 can enable users to annotate and evaluate a research paper while blinded to the commentary of other users, to information identifying the author of the research paper (such as name or affiliation), or to other types of data that may positively or negatively influence the user's review. For example, an author can request a period for blind evaluation after a paper is first uploaded to the publishing server 110. Alternatively, a reader can opt to give blind commentary on the paper. When blind review is requested, the browser application 130 displays the research paper without annotations or information that would identify the author. In some cases, the browser application 130 enables the reading user to turn off blinding in order to view information about the author or the other annotations on the paper. The browser application 130 can add data to each annotation received from a user that indicates whether the annotation was received before or after blinding was turned off.

### Annotating Research Papers

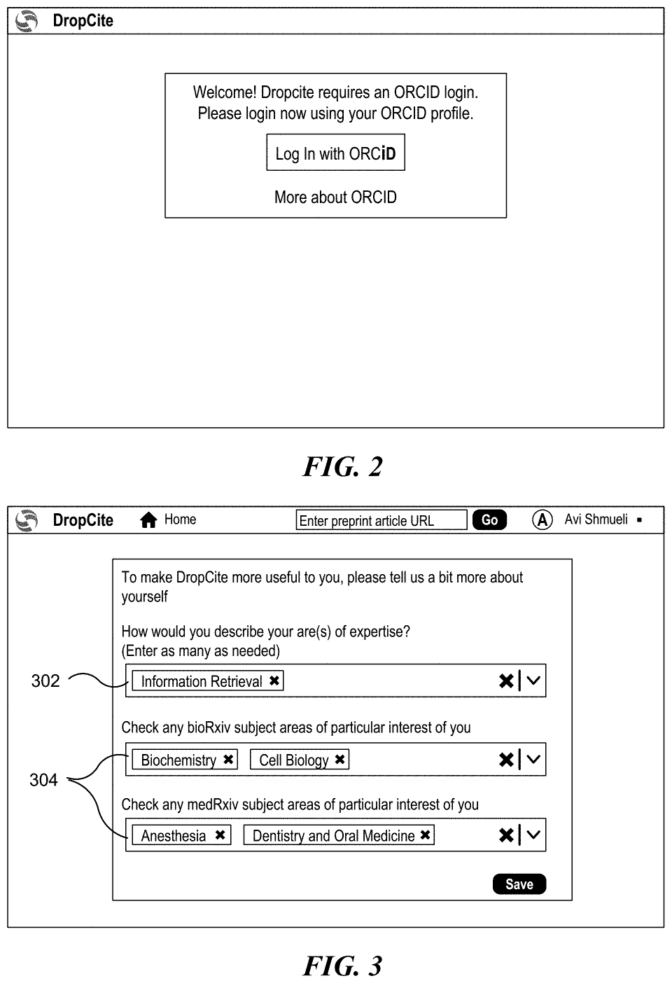

FIGS. 2-9 illustrate example user interfaces displayed to a user by the browser application 130, which enable a user to annotate research papers.

As shown in FIG. 2, a user can log into the browser application 130 upon accessing content from the publishing server 110. The login procedure may involve use of a researcher authentication platform such as ORCID.org that maintains a database of active researchers. Alternatively, the browser application 130 can facilitate a unique login associated with the LACE review server 120 or can retrieve persistent login credentials associated, for example, with a social media platform.

As shown in FIG. 3, the user can manage their subject matter preferences and expertise, which will guide the system in targeting content to their needs. For example, the user can manually enter areas of expertise at a user interface field 302 and subject areas of interest from one or more publishers at fields 304. The user interface fields 302, 304 can include drop-down lists specifying predefined subject areas that are selectable by the user or can facilitate free-form text entry in addition to or instead of the predefined options. In some cases, the user's subject matter preferences or expertise are derived by the LACE review server 120 and automatically populated into the fields 302, 304 shown in FIG. 3. The user can interact with the fields to add or remove subject areas of interest or expertise.

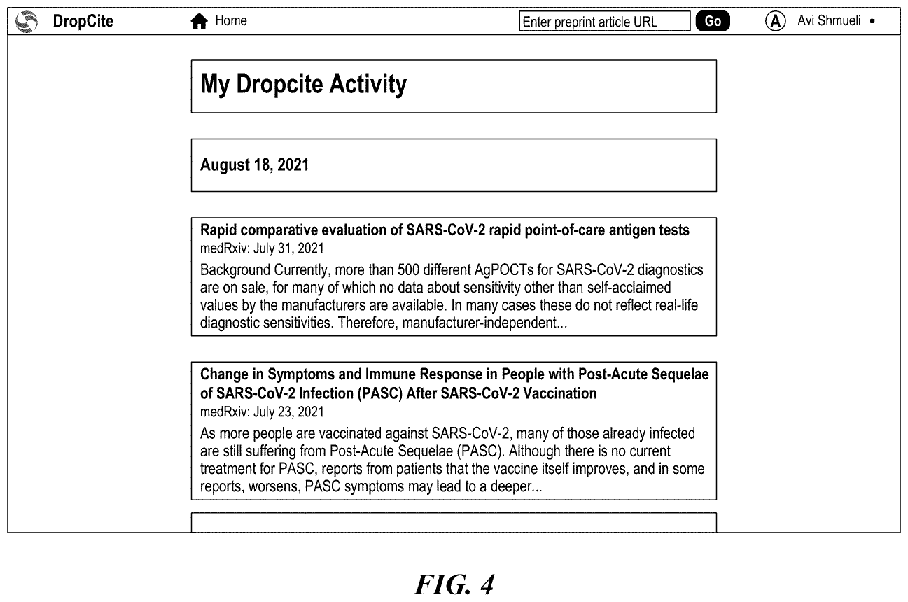

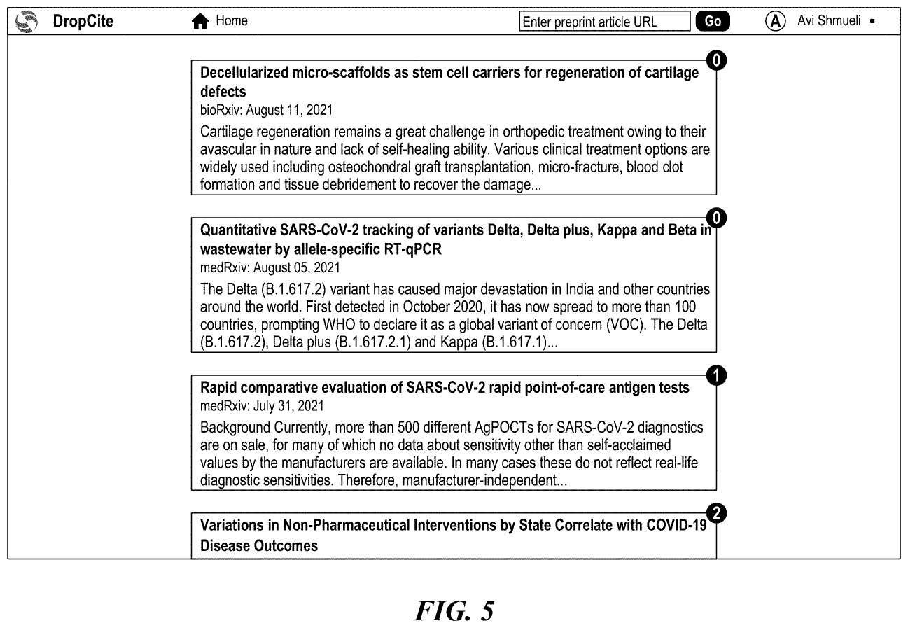

Once logged in, the browser application 130 displays a list of recommended research papers of potential interest to the user, as shown in FIG. 4. The list of papers can be selected at least in part based on the user's expertise or stated area of interest. For example, if the user's profile lists him as an expert in biochemistry, the browser application 130 displays biochemistry research papers that are available for review. Other features of the reviewing user or available research papers can be used to select the list of papers to display to the reviewing user, such as the number of annotations on the available papers, whether the reviewing user has previously commented on a paper by an author of an available paper, or whether the author of an available papers has previously reviewed a paper written by the reviewing user. In addition, textual analysis of the papers, and analysis of the reading, commenting, and reviewing patterns of the users, will generate clusters of similar users and similar papers assisting in targeting reviewers with the papers they are most likely to interact with, generating the most engaging and most fruitful annotations, and continuously improving the fit and relevance of the article targeted at each potential reviewer. As shown in FIG. 5, the browser application 130 can further enable the user to refer back to a record of their activity, finding research papers they have read, commented on, rated, or recommended.

In some cases, a user provides a review of a research paper by interacting with the browser application 130. When the user selects a research paper for potential review, the browser application 130 can first display an abstract of the paper to enable the user to determine whether to read, annotate, and/or evaluate the paper. In some cases, the browser application 130 hides information about the author of the paper and any previously received annotations during an initial review process, so as to reduce bias of the user reviewing the paper.

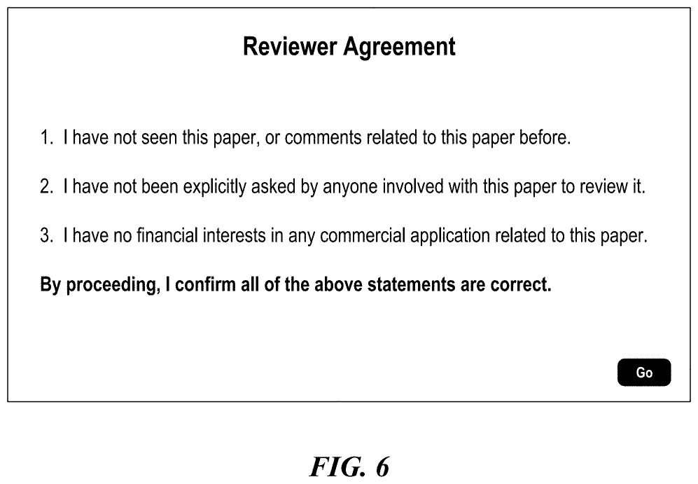

Once a user selects a paper to review, the browser application 130 can request a certification from the user. FIG. 6 illustrates a user interface with example certification statements. In the example of FIG. 6, the user certifies whether he or she has not previously seen the paper, has not been explicitly asked by anyone involved with the paper to review it, and does not have financial interests in any commercial application related to the paper. The LACE review server 120 stores the reviewing user's certifications in the user's profile, and may bar any user from evaluating papers if the user is later discovered to have made a false certification. In some cases, any annotations made by the user after completing the certification are sent to the author of the paper as part of a review process. If a user is unable to make the certification shown in FIG. 6, the LACE review server 120 can either block the user from annotating the paper or manage the user's annotations differently from those received from a certified reviewer. For example, the LACE review server 120 can tag annotations from non-certified users such that the annotations can be easily filtered out.

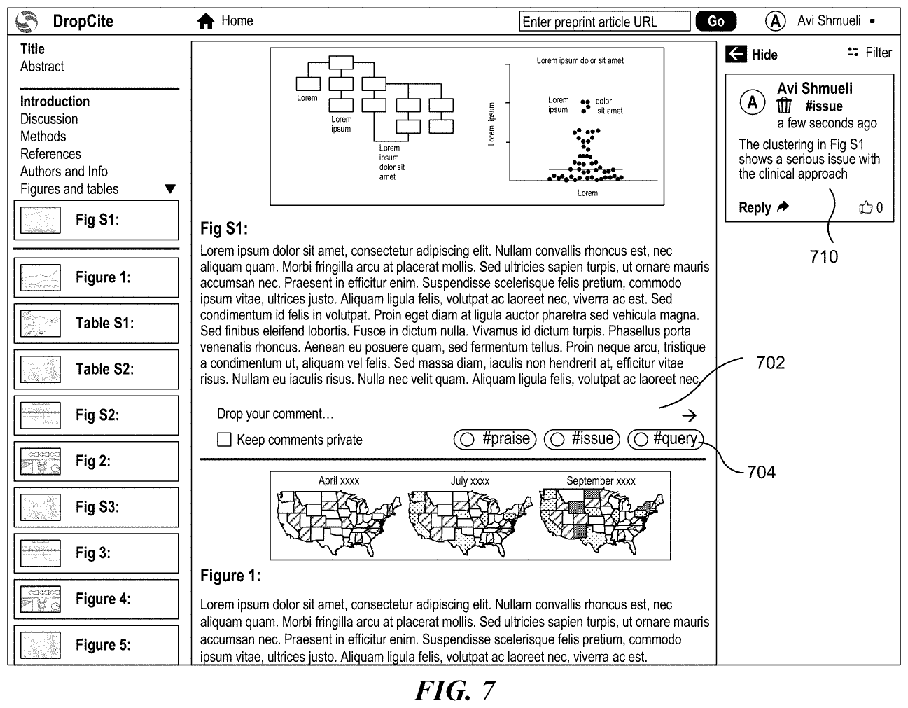

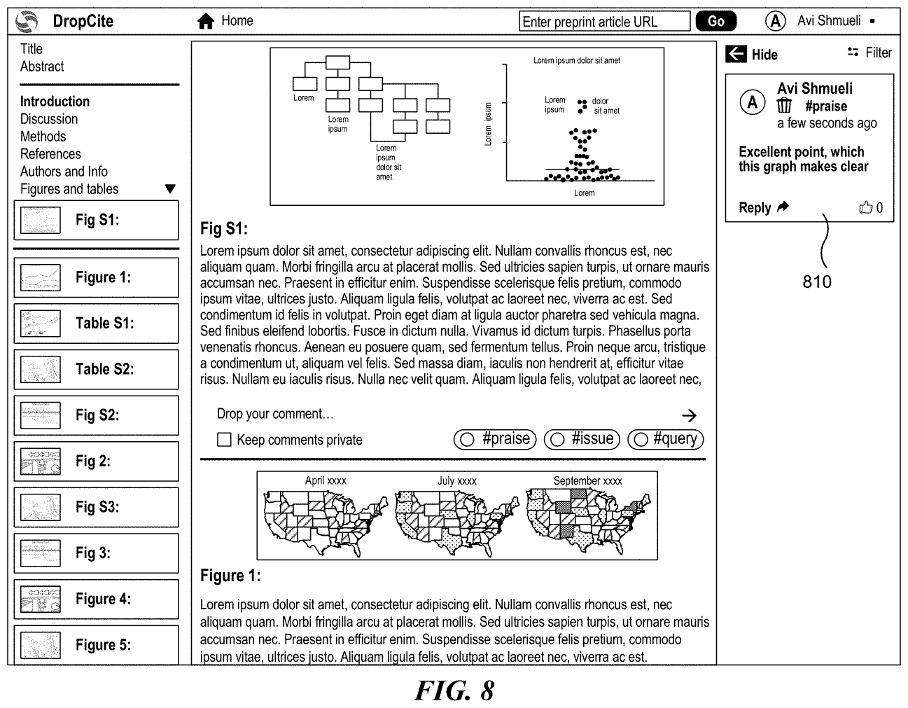

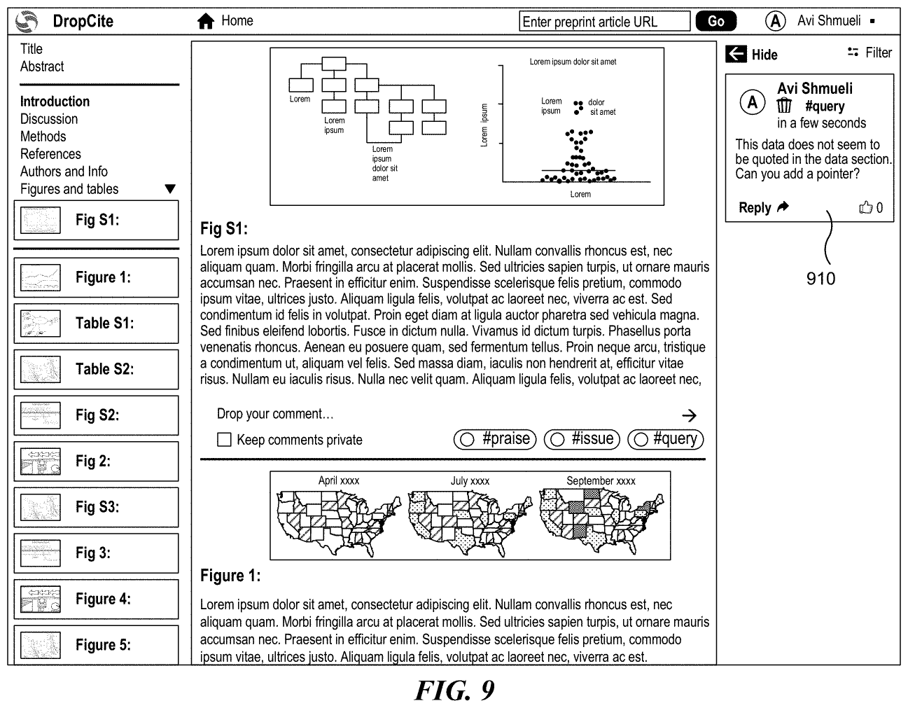

FIGS. 7-9 illustrate an example user interface for facilitating annotations of a research paper. As shown in FIG. 6, the browser application 130 enables the user to select a section 602 of text and add an annotation associated with the selected section. For example, the user can enter text into a text box 702. The user can also, optionally, add a tag to the annotation by, for example, selecting a hashtag 704. Predefined tags may include such gestures as intended to engage the author, and will in turn drive and prioritize the custom view serving the author when viewing their own article and its annotations. Such tags may include “# praise”, “# issue”, or “# query”, to indicate the semantics of annotations as either highlighting a good point in the article, raising an issue, or asking for a clarification, respectively. An example annotation 710 in FIG. 7 is tagged with the # issue hashtag, while an example annotation 810 in FIG. 8 is tagged with the # praise hashtag and an example annotation 910 in FIG. 9 is tagged with the # query hashtag. In addition, the browser application 130 can support user-defined hashtags extracted from the body of the annotations. These hashtags can serve the semantics to drive custom workflows within reviewers' groups, or to allow users to locate and associate annotations across multiple articles.

In addition to attaching explicit user-defined hashtags to annotations, the browser application 130 can attach data to each annotation that defines the expertise of the user, the affiliation of the user, or other types of information. Attaching this data to each annotation enables the annotations to be accessed based on the data. For example, as described further below, a user can filter a set of annotations associated with a research paper based on the expertise of the user who submitted each annotation. The attributes attached to an annotation can be directly attached (e.g., stored with the text of the annotation), added to the annotation as a pointer to an index of user attributes, or added as a pointer to a user's profile.

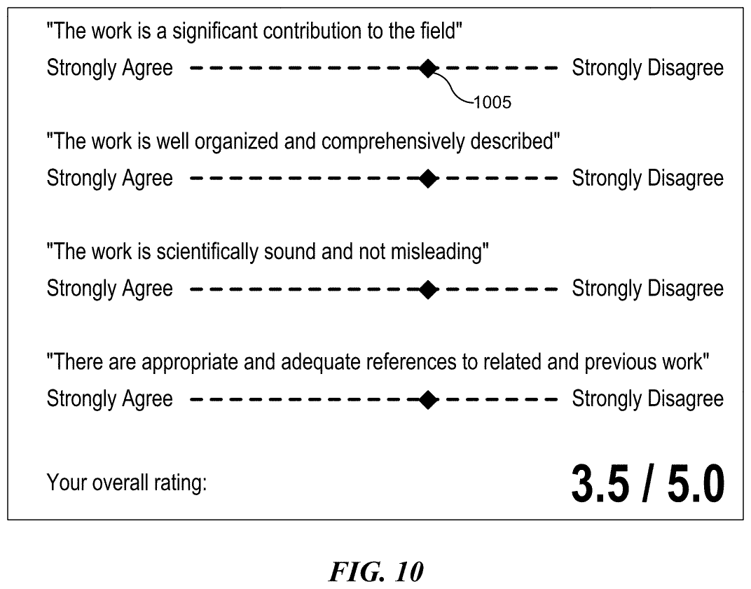

FIG. 10 illustrates an example user interface for receiving general comments and scores from the user. In some embodiments, the browser application 130 displays the user interface shown in FIG. 10 after the user indicates that he or she has finished adding specific comments to the text of the paper. As shown in FIG. 10, the interface asks the user to score the paper according to specified criteria, such as being a significant contribution to the field, being well organized and comprehensively described, setting forth work that is scientifically sound and not misleading, and containing appropriate and adequate references to related and previous work. The user interface includes an interface element 1005 to receive the reader's ratings for each of the specified criteria. In the example of FIG. 10, the interface elements 1005 are slider scales that the user can adjust along a scale from “strongly agree” to “strongly disagree.” Other embodiments of the user interface include different configurations of the interface elements 1005, such as drop-down lists, radio buttons, or text entry boxes.

The LACE review server 120 stores the user's annotations and feedback in association with the research paper. The score provided by the user can be aggregated with scores received from other users to assign an overall score to the research paper. The LACE review server 120 may also provide the annotations and feedback to the paper's author. In some cases, the annotations and feedback are displayed to the author by the browser application 130.

Revising and acting on users' comments will depend on the context of the publishing server 130. When the publishing server 130 allows for multiple, consecutive versions for the same research paper, the LACE review server 120 will alert each reader to the publishing of a new version and will drive a user interface in the browser application 130 to assist readers who commented on or evaluated the previous version in either migrating their comments or evaluations to the new version of the article, or resolving them as addressed. In some implementations, the publishing server 130 and the LACE review server 120 are tightly integrated, and the comments are part of a coherent publishing workflow hosted at the publishing server 130, in which the author can make discrete changes to the text in response to specific comments. The facility to reply to comments using the browser application 130, as well as tagging comments as resolved, can then be used to support a dialog between commenters and the author within the context of editing the research article as part of the publishing workflow.

The browser application 130 can afford both explicit and implicit mechanisms to improve the nature of the collaborative annotation and evaluation. Users can choose not to view other users' annotations as they read the research paper or can opt to read the paper side-by-side with other users' annotations. The browser application 130 can distinguish between annotations made with or without seeing other users' annotations on the article. Users can also use the browser application 130 to filter annotations explicitly by the reviewer's affiliations, expertise, identity, or by tags associated with the annotations. Implicitly, the browser application 130 can prioritize annotations based on their acceptance by other users or by users' similarity or explicit connection to a reading user. Similarly, the browser application 130 can prioritize annotations from users whose expertise is more relevant to the article's subject matter or to the specific section associated with each annotation. Finally, using a custom navigation interface, the browser application 130 enables users to quickly identify, and navigate directly to, sections of the document that generated positive annotations, queries, or suggestions, as well as annotations that generated multiple replies.

The browser application 130 can further enable users to create a group of other users that they follow or choose to connect with. Commentary from that group can be prioritized when the browser application displays annotations to the user.

### Presenting Research Papers with Crowdsourced Commentary and Evaluation

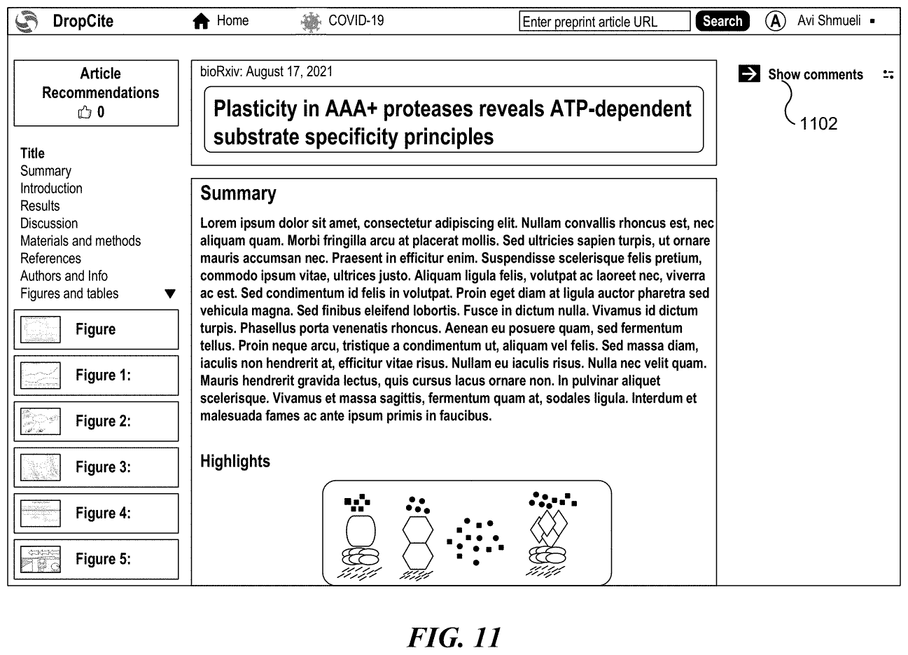

The browser application 130 enables users to access research papers together with reviewer comments and author responses that are associated with each research paper. Additionally, users can add their own annotations and view or respond to annotations by reviewers, authors, or other users. By integrating comment functionality into the context of a dynamic online research paper, the browser application 130 facilitates active discussion of the paper that is centered around the paper itself and is anchored in context. FIGS. 11-14 illustrate example user interfaces generated by the browser application while a user reads a research paper.

As described above with respect to FIGS. 2-5, a user can log into the browser application 130 and select a research paper to read. When the user selects a paper to view, the user can opt to view the paper with no annotations, as shown in FIG. 11. If the user desires to view the paper with annotations, the user can select a “show comments” link 1102.

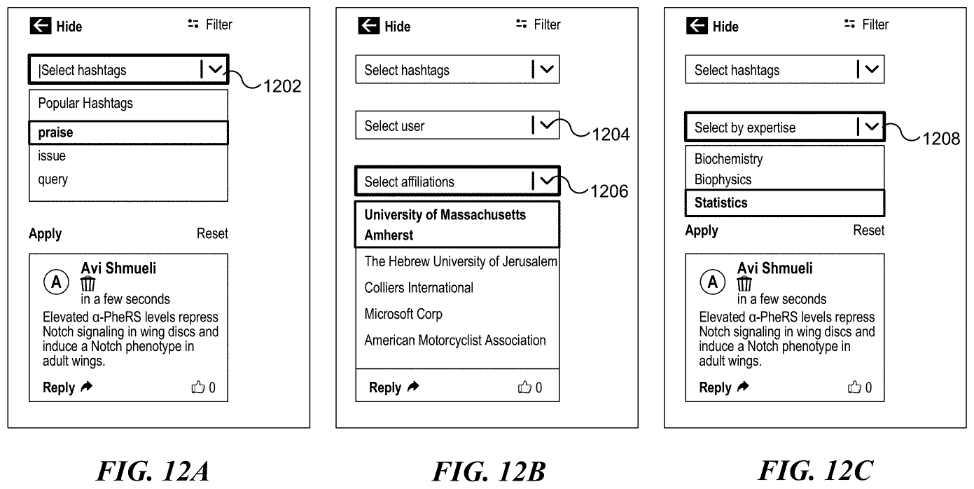

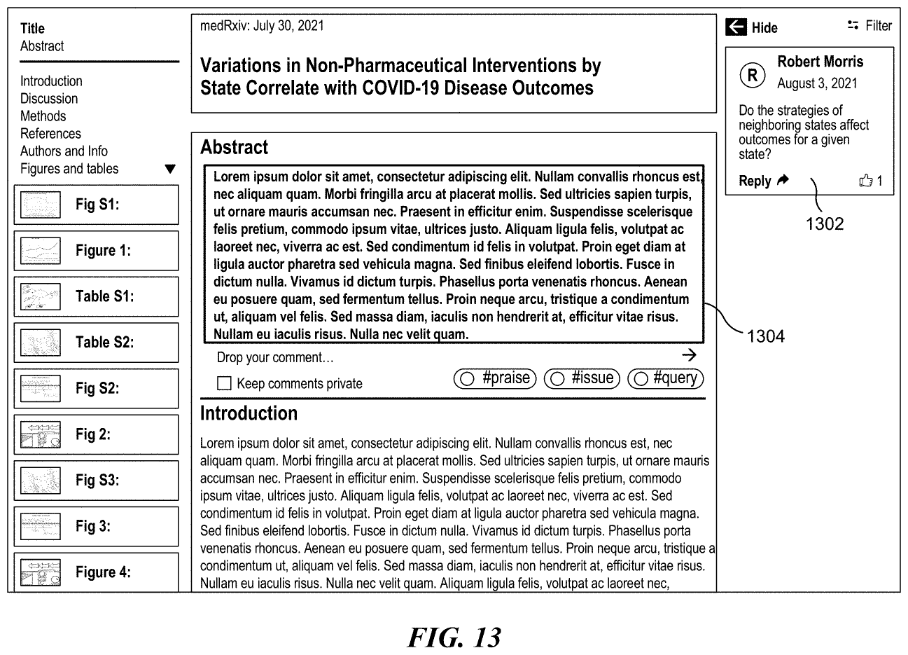

When viewing a paper with annotations, the user can apply one or more filters to the set of comments associated with the paper. FIGS. 12A-12C shows example user interfaces enabling a user to filter the annotations. For example, the user can filter by hashtag applied to the annotations by selecting a hashtag from a menu 1202, shown in FIG. 12A. FIG. 12B illustrates that the user can filter by the user who provided the annotation using the menu 1204, or by the institution with which the annotating user is affiliated using the menu 1206.

FIG. 12C illustrates the annotations can be filtered at menu 1208 by the expertise of the annotating user. The subjects listed in the menu 1208 can be the same for any research paper released by the publishing server 110 or selected based on the subject matter of the particular paper or section of paper being viewed. For example, the menu 1208 in FIG. 12C contains an option to filter to users who are experts in biochemistry because the research paper is tagged as being a paper related to biochemistry. The paper can have one or more tags identifying the overall subject matter or subject matter associated with sections of the paper. If, for example, the research paper has a section dedicated to a statistical analysis of experimental results, the reading user may be given the option to filter the comments to those provided by experts in statistics while the reading user reads the statistical analysis section. Section-specific expertise can be identified by the browser application 130 or LACE review server 120 using textual analysis and scanning for keywords and phrases that indicators of specific concepts within specific scientific subject matters. Alternatively, the browser application 130 or LACE review server 120 can infer the relevant expertise associated with a section based on the expertise of users who annotate the section.

Any of a variety of other filters can be provided in addition to or instead of those shown in FIGS. 12A-12C, including filtering by comment score, by the number of replies to an annotation, by date the annotation was received, or by the context in which the annotation was received (e.g., whether it was provided as a blind review). The browser application 130 can enable the user to dynamically add or remove filters while reviewing the paper, for example to enable the user to view and interact with commentary by different types of users for different sections of the paper.

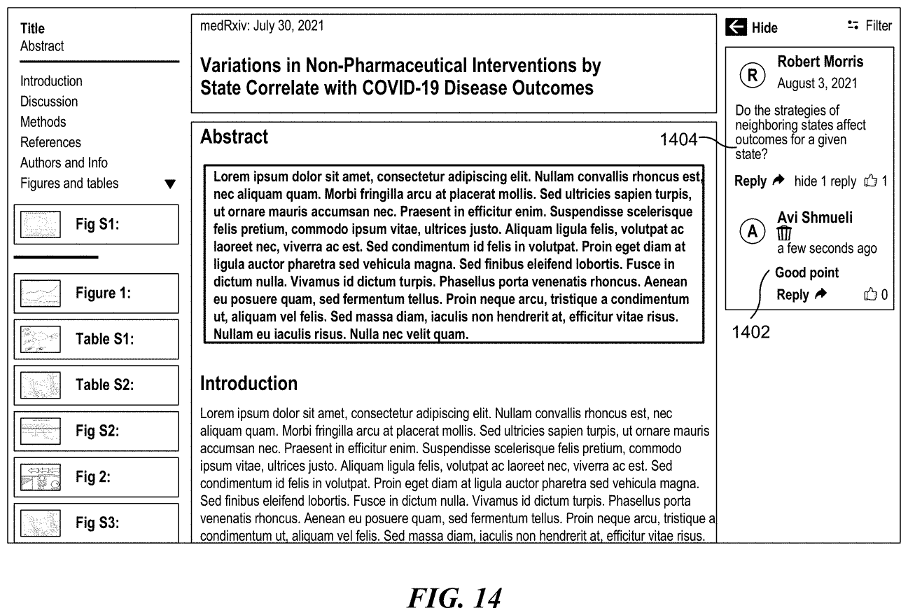

FIGS. 13 and 14 illustrate example user interfaces displayed by the browser application 130 while a user reads a paper with annotations.

As shown in FIG. 13, while a user views a research paper, the browser application 130 displays annotations associated with the research paper (such as the annotation 1302). The browser application 130 can display an indicator 1304 showing the section of text with which each comment is associated. For example, in FIG. 13, the indicator 1304 is a box highlighting a paragraph of text. The indicator 1304 can be any of a variety of objects or modifications to text to distinguish the text associated with a comment from text not associated with comments, including different colors or styles of boxes around the text, underlining of the text, or a modification to the font color, font size, or font style.

To provide the user with an overview of the comments in an article, to facilitate the navigation of the article and the comments associated with the different sections, and to best communicate the volume and nature of the comments, the browser application 130 can present a “comment stack” display, which may combine a table of contents for the article or a series of page thumbnails with a graphical summary display of the comments by color and labels. Annotations tagged with a hashtag, such as # issue, # query or # praise, are displayed with distinguishing formatting, such as a distinct color and identifying labels. Replies and other annotations can be displayed in a different color. The browser application 130 can further display an element identifying a number of comments associated with the indicated section of text, allowing users to quickly identify sections in text that generate certain type of comments, or that generate a large volume of replies. In some implementations, this navigation tool can be used with a text search to help the user locate instances of the words of interest in the document.

While reading the paper, the browser application 130 enables the user to provide additional annotations or post a response to an annotation from another user. For example, FIG. 14 illustrates that a user can input a text-based reply 1402 to another user's annotation 1404. The LACE review server 120 stores the user's annotations in association with the research paper. Any annotations provided by the reading user are stored with information identifying the reading user, such as the reading user's profile name and expertise. Thus, when other users access the paper, the other users can evaluate or filter the reading user's annotations or interact with the reading user's annotations in similar manners as the annotations from the reviewer or authors.

### Managing Annotation, Collaboration, Evaluation and Recommendation of Research Papers

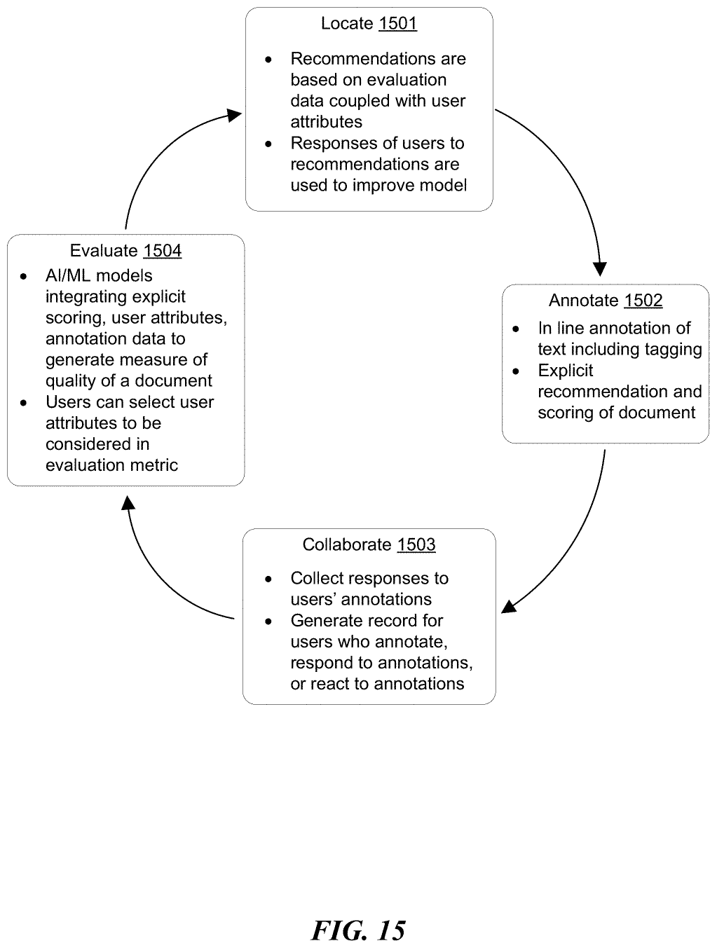

FIG. 15 is a flowchart illustrating a process 1500 for managing research paper evaluation, and recommendation based on data collected during annotation and collaboration. The process 1500 can be performed by a computer system, such as the LACE review server 120. Other implementations of the process 1500 include additional, fewer, or different steps, or perform the steps in different orders.

During the process of annotation 1502, users can tag papers to indicate sentiment of the comment. Sentiment can also be assessed by natural language processing. Users can also be asked to provide explicit scoring of a paper and to indicate if they would recommend the paper.

The responses of other users to those comments 1503 can be used to assess the perceived validity of those comments, both through natural language processing of replies and through explicit gestures, such as upvoting a comment. Patterns of responses to a particular commenter can also be used to create a rating system for commenters to assess the general perception of the validity of their comments.

The LACE review server 120 applies one or more collaborative artificial intelligence and machine learning models to evaluate scientific papers, identify papers that best fit the interests and attributes of individual users and recommend papers to those users.

For the task of evaluating paper quality 1504, the review server 120 can generate and initial assessment of quality is based on meta-data related to the paper such as publication history and academic history of the authors to provide a first approximation of the quality and importance of the research papers. Quality can be assessed independent of the reviewers' interests or attributes to construct a static rank (or a series of static ranks) for research papers, within different scientific areas and topic categories. Both high-quality and low-quality papers may have special value in the review system. Quality can be measured in terms of success measures in a traditional academic review system (such as the likelihood for an article to be published, the prestige associated with the ultimate publishing venue, and the time it takes a preprint to be published) and/or measures that are intrinsic to interactions within the LACE review system 120 (such as a continuously updated model assessing articles' quality based on reviewers' ratings, comments' tone, and reviewers' ratings and reactions to other reviewers' annotations). To protect against a run-away social network effect where social popularity may overpower good science, the LACE review system 120 can combine, weigh, and reinforce various signals by giving additional weight to annotations and other signals collected from a core, index group of reviewers used as a quality index. The index group of reviewers can be specified for a given subject area, for example by continuous review guided by a scientific advisory board. In some implementations, additional weight can also be given to highly rated reviewers based on the number of “thumbs up” ratings or positive replies to their annotations as well as how often their ratings of papers predict the subsequent community ratings of those papers. Comments that have been made while blinded can also be given extra weight.

The evaluation outlined above will be used to generate a set of one or more indices to describe the quality and scientific importance of a particular paper. The content of that set of indices can be controlled by the user based on the attributes of the users whose ratings and comments are to be incorporated in that set of indices. For example, a user could request a set of indices derived only from statisticians or only from highly ranked commenters or from users with a combination attributes.

To predict the impact a research paper will have on science and/or society, the LACE review server 120 applies metadata and full-text-based models to infer the likelihood of research papers to generate interest. For constructing and improving the models, publicly and commercially available data about the discussion of papers in social media forums can be combined with internal data from the LACE server 120 databases.

For the task of matching papers with the right reviewers 1501, the review server 120 automatically maintains a profile of each reviewer's interests, based on their explicit declarations of interests and expertise, and then enhanced by inference from attributes and features extracted from the research papers and comments with which they interact, using machine learning and natural language processing algorithms. The profile is then enhanced by observing users' interaction via replies and reactions to comments, “follows”, membership in user groups, similarities in bio or other profile elements, and other collaborative gestures that the browser application will make available to users, to construct a dynamic user network and then traverse it to enhance its recommendations by inferring common or related interests among users.

A “machine learning model,” as used herein, refers to a construct that is trained using training data to make predictions or provide probabilities for new data items, whether or not the new data items were included in the training data. For example, training data for supervised learning can include items with various parameters and an assigned classification. A new data item can have parameters that a model can use to assign a classification to the new data item. As another example, a model can be a probability distribution resulting from the analysis of training data, such as a likelihood of an n-gram occurring in a given language based on an analysis of a large corpus from that language. Examples of models include neural networks, support vector machines, decision trees, Parzen windows, Bayes clustering, reinforcement learning, probability distributions, decision trees, decision tree forests, and others. Models can be configured for various situations, data types, sources, and output formats.

In some implementations, one or more of the models used by the LACE review server 120 is a neural network with multiple input nodes that receive an input data point or signal, such as text extracted from a research paper. The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer (“the output layer”), one or more nodes can produce a value classifying the input. In some implementations, such neural networks, known as deep neural networks, can have multiple layers of intermediate nodes with different configurations, can be a combination of models that receive different parts of the input and/or input from other parts of the deep neural network, or are convolutions—partially using output from previous iterations of applying the model as further input to produce results for the current input.

A machine learning model can be trained with supervised learning, where the training data includes inputs and desired outputs. The inputs can include, for example, text extracted from a research paper. The desired outputs can include a label that classifies the research paper as being associated with a specified subject area. As the machine learning model is trained, output from the model can be compared to the expected output and, based on the comparison, the model can be modified, such as by changing weights between nodes of the neural network or parameters of the functions used at each node in the neural network (e.g., applying a loss function). After applying each of the data points in the training data and modifying the model in this manner, the model can be trained to evaluate new data points (such as new research papers) to generate new outputs (such as subject matter classifications of the research papers).

### Example Processing System and Conclusion

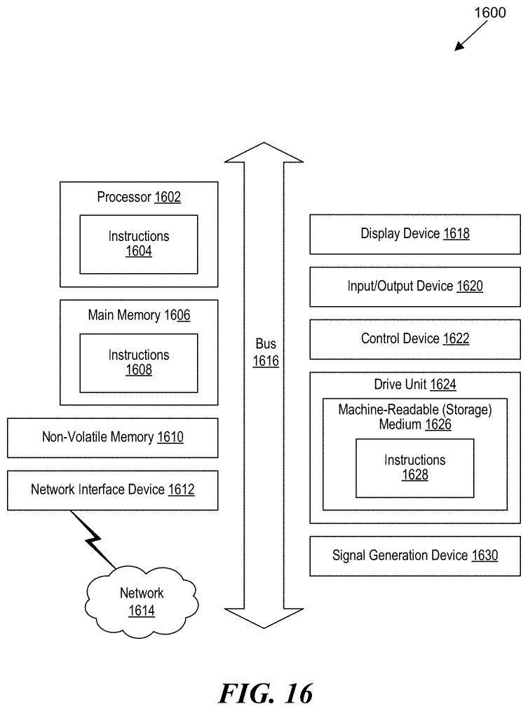

FIG. 16 is a block diagram illustrating an example of a processing system 1600 in which at least some operations described herein can be implemented. For example, one or more of the publishing server 110, the LACE review server 120, or a user device 111 executing the browser application 130 may be implemented as the example processing system 1600. The processing system 1600 may include one or more central processing units (“processors”) 1602, main memory 1606, non-volatile memory 1610, network adapter 1612 (e.g., network interfaces), video display 1618, input/output devices 1620, control device 1622 (e.g., keyboard and pointing devices), drive unit 1624 including a storage medium 1626, and signal generation device 1630 that are communicatively connected to a bus 1616. The bus 1616 is illustrated as an abstraction that represents any one or more separate physical buses, point to point connections, or both connected by appropriate bridges, adapters, or controllers. The bus 1616, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1694 bus, also called “Firewire.”

In various embodiments, the processing system 1600 operates as part of a user device, although the processing system 1600 may also be connected (e.g., wired or wirelessly) to the user device. In a networked deployment, the processing system 1600 may operate in the capacity of a server or a client machine in a client-server network environment, or as a peer machine in a peer-to-peer (or distributed) network environment.

The processing system 1600 may be a server computer, a client computer, a personal computer, a tablet, a laptop computer, a personal digital assistant (PDA), a cellular phone, a processor, a web appliance, a network router, switch or bridge, a console, a hand-held console, a gaming device, a music player, network-connected (“smart”) televisions, television-connected devices, or any portable device or machine capable of executing a set of instructions (sequential or otherwise) that specify actions to be taken by the processing system 1600.

While the main memory 1606, non-volatile memory 1610, and storage medium 1626 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 1628. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure, may be implemented as part of an operating system or a specific application, component, program, object, module or sequence of instructions referred to as “computer programs.” The computer programs typically comprise one or more instructions (e.g., instructions 1604, 1608, 1628) set at various times in various memory and storage devices in a computer, and that, when read and executed by one or more processing units or processors 1602, cause the processing system 1600 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. For example, the technology described herein could be implemented using virtual machines or cloud computing services.

Further examples of machine-readable storage media, machine-readable media, or computer-readable (storage) media include, but are not limited to, recordable type media such as volatile and non-volatile memory devices 1610, floppy and other removable disks, hard disk drives, optical disks (e.g., Compact Disk Read-Only Memory (CD ROMS), Digital Versatile Disks (DVDs)), and transmission type media, such as digital and analog communication links.

The network adapter 1612 enables the processing system 1600 to mediate data in a network 1614 with an entity that is external to the processing system 1600 through any known and/or convenient communications protocol supported by the processing system 1600 and the external entity. The network adapter 1612 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 1612 can include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list which details permissions including for example, the access and operation rights of an object by an individual, a machine, and/or an application, and the circumstances under which the permission rights stand.

As indicated above, the techniques introduced here implemented by, for example, programmable circuitry (e.g., one or more microprocessors), programmed with software and/or firmware, entirely in special-purpose hardwired (i.e., non-programmable) circuitry, or in a combination or such forms. Special-purpose circuitry can be in the form of, for example, one or more application-specific integrated circuits (ASICs), programmable logic devices (PLDs), field-programmable gate arrays (FPGAs), etc.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or in direct, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, in general, the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

Any patents and applications and other references noted above, including any that may be listed in accompanying filing papers as well as and the applicant's concurrently filed U.S. application Ser. No. ______, entitled ENHANCING MACHINE LEARNING MODELS TO EVALUATE ELECTRONIC DOCUMENTS BASED ON USER INTERACTION (Attorney Docket No. 140651-8001.US02), are incorporated herein by reference in their entirety, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A method comprising:
displaying, by a computer system, a research paper within a browser application;
receiving at the computer system, from a first user of the browser application, an input to define a first annotation to be linked with a portion of the research paper;
associating, by the computer system, an attribute of the first user with the first annotation,
wherein the attribute of the first user is derived at least in part from historical activities of the first user with respect to the browser application; and
publishing, by the computer system, the first annotation in association with the research paper and linked to the portion of the research paper,
wherein the browser application is caused to display the first annotation to a second user based at least in part on the attribute of the first user that is associated with the first annotation.

2. The method of claim 1, wherein the research paper includes text identifying an author of the research paper, and wherein displaying the research paper comprises:
displaying the research paper without the text identifying the author prior to receiving the input to define the first annotation from the first user.

3. The method of claim 2, further comprising:
associating with the first annotation, data identifying that the first annotation was received prior to the text identifying the author having been displayed to the first user;
wherein the data identifying that the first annotation was received prior to text identifying the author having been displayed to the first user is the attribute based on which the browser application is caused to display the first annotation.

4. The method of claim 2, wherein displaying the research paper comprises:
identifying a review period for the research paper, the review period specifying an amount of time after initial publication of the research paper during which the research paper is to be displayed without the text identifying the author;
receiving a request from the first user to access the research paper;
determining whether the request from the first user was received during the review period for the research paper; and
responsive to determining the request from the first user was received during the review period, displaying the research paper without the text identifying the author.

5. The method of claim 1, wherein the attribute of the first user includes an expertise of the first user, and wherein the browser application is caused to display the first annotation if the expertise of the first user matches a specified user expertise.

6. The method of claim 1, wherein the attribute of the first user includes an expertise of the first user, and wherein the method further comprises:
determining a subject area of the research paper;
wherein the browser application is caused to display the first annotation if the expertise of the first user matches the determined subject area of the research paper.

7. The method of claim 1, wherein the attribute of the first user includes an expertise of the first user, and wherein the method further comprises:
determining a subject area of the portion of the research paper to which the first annotation is linked;
wherein the browser application is caused to display the first annotation if the expertise of the first user matches the determined subject area of the portion of the research paper.

8. The method of claim 1, further comprising:
performing natural language processing analysis on multiple research papers available through a web server to identify at least one subject matter associated with each of the multiple research papers; and
recommending a first research paper of the multiple research papers to the first user based on identifying a match between the at least one subject matter associated with the first research paper and the attribute of the first user.

9. The method of claim 1, further comprising:
generate a score for the first annotation;
wherein the browser application is further caused to display the first annotation to the second user based on the score for the first annotation.

10. The method of claim 1, wherein receiving the input to define the first annotation comprises receiving a tag from the first user to associated with the first annotation, and wherein the browser application is further caused to display the first annotation to the second user based on the tag.

11. The method of claim 1, further comprising:
accessing, by the computer system, a set of additional research papers;
applying, by the computer system, one or more trained models to the historical activities of the first user with respect to the browser application and attributes extracted or derived from each of the research papers in the set of additional research papers,
wherein the one or more trained models when applied to the detected historical activities and the extracted or derived attributes are configured to generate a recommendation for another research paper for the first user that is selected from the set of additional research papers; and
providing, by the computer system, the recommendation for the other research paper to the first user.

12. At least one computer-readable storage medium, excluding transitory signals and carrying instructions, which, when executed by at least one data processor of a system, cause the system to:
display a research paper within a browser application;
receive, from a first user of the browser application, an input to define a first annotation to be linked with a portion of the research paper;
associate an attribute of the first user with the first annotation, wherein the attribute of the first user is derived from historical activities of the first user with respect to the browser application; and
publish the first annotation in association with the research paper and linked to the portion of the research paper,
wherein the browser application is caused to display the first annotation to a second user based at least in part on the attribute of the first user that is associated with the first annotation.

13. The at least one computer readable storage medium of claim 12, wherein the research paper includes text identifying an author of the research paper, and wherein displaying the research paper comprises:
displaying the research paper without the text identifying the author prior to receiving the input to define the first annotation from the first user;
associating with the first annotation, data identifying that the first annotation was received prior to the text identifying the author having been displayed to the first user;
wherein the data identifying that the first annotation was received prior to text identifying the author having been displayed to the first user is the attribute based on which the browser application is caused to display the first annotation.

14. The at least one computer readable storage medium of claim 12, wherein the attribute of the first user includes an expertise of the first user, and wherein the browser application is caused to display the first annotation if the expertise of the first user matches a specified user expertise.

15. The at least one computer readable storage medium of claim 12, wherein the instructions when executed further cause the system to:
generate a score for the first annotation;
wherein the browser application is further caused to display the first annotation to the second user based on the score for the first annotation.

16. The at least one computer readable storage medium of claim 12, wherein receiving the input to define the first annotation comprises receiving a tag from the first user to associated with the first annotation, and wherein the browser application is further caused to display the first annotation to the second user based on the tag.

17. A system, comprising:
at least one hardware processor; and
at least one non-transitory memory storing instructions, which, when executed by the at least one hardware processor, cause the system to:
display a research paper within a browser application;
receive, from a first user of the browser application, an input defined as a first annotation to be linked with a specific section of the research paper;
associate with the annotation, one or more tags selected by the first user and one or more attributes associated with the first user, the attributes including the first user's field of expertise, professional affiliations, and a general quality score of prior annotations by the first user;
display the research paper to a second user of the system within a browser application;
displaying a set of annotations associated with the research paper to the second user, the set of annotations selected for display by the browser application based on criteria selected by the second user;
wherein the first annotation is selected for inclusion in the set of annotations if the criteria selected by the second user matches at least one of the one or more tags selected by the first user or the one or more attributes associated with the first user.

18. The system of claim 17, wherein the instructions when executed further cause the system to:
derive the quality score for the prior annotations by the first user based on responses to the prior annotations by other users of the system.

19. The system of claim 17, wherein the attribute of the first user includes an expertise of the first user, and wherein the first annotation is selected for inclusion in the set of annotations if the expertise of the first user matches a specified user expertise.

20. The system of claim 17, wherein the instructions when executed further cause the system to:
generate a score for the first annotation;
wherein the first annotation is selected for inclusion in the set of annotations based on the score for the first annotation.
